(19) United States
(12) Patent Application Publication
(10) Pub. No.: US 2024/0184561 A1
(43) Pub. Date: Jun. 6, 2024

(54) Communication Device for Managing One or More Aspects of a Vehicle Through Remote Monitoring

(71) Applicant: Kamp Technologies, LLC, Columbus, IN (US)

(72) Inventor: Alyn G Brown, Nashville, IN (US)

(21) Appl. No.: 18/441,960

(22) Filed: Feb. 14, 2024

Related U.S. Application Data
(63) Continuation-in-part of application No. 17/233,417, filed on Apr. 16, 2021.
(60) Provisional application No. 63/011,171, filed on Apr. 16, 2020.

(51) Int. Cl. G06F 8/65; G07C 5/00; H04L 12/40

(52) U.S. Cl. CPC G06F 8/65; H04L 12/40; G07C 5/008; H04L 2012/40215

(57) ABSTRACT

A communication device for connection to a serial bus (e.g. CAN Bus) of a vehicle/machine includes processing, memory, sensors, and communications that provides communication between and control of components/aspects of the vehicle/machine connected to the vehicle's CAN Bus with and by a remote personal processing device (e.g. a smart phone or tablet) of a remote user via only the Cloud. The Cloud also provides data to the communication device. Programming (e.g. an app) running on the remote personal processing device allows the user to provide data regarding the vehicle's/machine's components and aspects thereof to the communication device and thus the vehicle/machine via only the Cloud. The Cloud may store programming for the vehicle/machine that is provided to the vehicle, preferably but not necessarily, upon receipt of certain vehicle data from the communication device. The communication device may use cellular communications, and include near-field communications.

### CROSS-REFERENCE TO RELATED APPLICATIONS

This U.S. non-provisional patent application is a continuation-in-part of U.S. non-provisional patent application Ser. No. 17/233,417 filed Apr. 16, 2021 titled “Communication Device for Managing One or More Aspects of a Vehicle Through Remote Monitoring,” which claims the benefit of U.S. provisional patent application Ser. No. 63/011,171 filed Apr. 16, 2020 titled “Communication Device for Managing One or More Aspects of a Vehicle Through Remote Monitoring,” the entire contents of each of which are expressly incorporated herein by reference.

### TECHNICAL FIELD OF THE INVENTION

The present invention relates to communication devices and, more particularly, to communication devices and techniques for remotely monitoring one or more vehicles, and controlling the operation of the vehicles in response to signals that are sent from the vehicle to a remote processor, such as a mobile phone, and are sent from the remote processor to the communication device that is mounted on the vehicle, and which is in communication with various of the vehicle sensors and controllers.

### BACKGROUND OF THE INVENTION

A large number of vehicles having engine systems and drive systems exist that include several parameters that are capable of being monitored so that a remote user can monitor aspects of the vehicle, such as its engine, drive system, position, operational status, the status of its accessories, and its attitude, so that the remote use can obtain a good picture of the status and operation of the vehicle.

By monitoring these parameters, a remote user can help to implement desired actions by the vehicle, monitor whether the vehicle is on schedule for particular task, monitor vehicular efficiency and cost effectiveness and also monitor the overall performance of the vehicle along with the compliance of the vehicle's operator with applicable regulations, locations, and routes, and also instructions given to the user by appropriate authority, such as governmental authorities and, more particularly, the employer or controller of the user.

Although devices exist that perform one or more of these functions, room for improvement exists. In particular, room for improvement exists in providing a device that is capable of providing a communication device between a vehicle having an engine and a drive system, and a remote user that enables the remote user to both monitor the operation of the vehicle, and also to control the operation of the vehicle, or at least certain aspects of the operation of the vehicle.

### SUMMARY OF THE INVENTION

A Communication System and Device is provided for use with a mobile vehicle having an electric motor or an internal combustion engine, a drive system, a vehicle communication network or bus and a plurality of sensors, including at least a first, second, and third sensor selected from at least one of (i) an engine sensor, (ii) a drive system sensor, (iii) a position sensor, (iv) an operational status sensor, (v) an accessory status sensor, and (vi) an attitude sensor, and at least one controller for controlling operation of at least one of the engine, drive system, and accessory, the communication device providing data regarding the mobile vehicle to and from a remote processing device of a remote user via and in conjunction with the Cloud.

In one form, the remote processing device is a cell phone with an application (app). Between the cell phone and the vehicle mounted communication device, everything goes to the Cloud first. There is no direct communication from the cell phone application to the communication device. The communication device is in constant two-way communication with the Cloud via typically a cellular connection (or could be satellite) so data from the communication device is being sent to Cloud storage, and any information (data) that needs to go to the communication device will go from the Cloud to the communication device. The application or computer programming accesses the data that is stored on the Cloud so everything that you are looking at from your cell phone application is data collected, stored, and processed on the Cloud and then accessed by the cell phone/application. Commands that are desired to be sent to the communication device would go from the cell phone to the Cloud to the communication device.

In a second form a cellular modem is incorporated into the electronics box of the present invention, so that no additional cell phone is required. In this configuration the cellular modem is in communication with a microprocessor. The microprocessor is also in communication with the serial network of the vehicle. The cellular modem allows the serial network of the vehicle to be in direct communication with a remote device.

The Communication Device comprises a processor mounted on the vehicle. The processor includes at least one input link and at least one output link and a communication link. A transceiver is provided in communication with the processor for sending data to and receiving data from a remote processor. The input link of the communication device is capable of receiving data from at least each of the first, second, and third sensors, and communicating the received data to the processor, the transceiver and the remote processor. The output link is capable of communicating data received from the remote processor and transceiver to the controller for controlling the operation of at least one of the drive system, engine, and accessory.

One feature of the present invention is that as a communication device it can be connected to lawn equipment to allow two-way communication from a remote processor, such as a smart phone, to a powered lawn equipment device that is anywhere in the world that is capable of receiving a remote signal, such as a mobile telephone signal, a Wi-Fi signal, or a satellite phone type signal. This feature has the advantage of enabling the user to know not only the location and current status of the lawn equipment device but also be in full communication with the vehicle, and preferably, but not necessarily, its components.

The communication device additionally enables the user to monitor a vehicle communication network and/or connections such as, but not limited to, a CAN Bus remotely and be notified of equipment/component/device failures or issues instantly. Additionally, the user can be alerted to any accidents, rollovers, or other potential issues that affect the communication device.

For vehicles, such as mobility scooters, that do not have existing Serial Bus, or Can Bus Networks, A plurality of analog and digital inputs can be connected to the various sensors and controllers on the vehicle. For example, a digital input can be used to detect whether the seat switch has been activated, a digital input can be configured to detect whether a brake input has been activated, and an analog input can be configured to detect battery voltage. The Device can also be configured to provide analog or digital outputs to the vehicle. For example, a dash board light can be activated under certain circumstances, a horn or buzzer can be activated, or the functionality of the drive could be modified.

Not only can the user be notified of these, but the user can activate and deactivate the one or more of the vehicle's active operating parts, such as its accessories, its engine, or its drive system/components thereof. Further, the communication device can provide maintenance reminders to the user.

A further benefit of the current invention is the ability to remotely update the software of components that are connected to the serial network and to the device. For example, if a vehicle equipped with the Device includes electronic motor controllers, then firmware updates of the connected electronic motor controller can be done through the device. To further illustrate this unique feature, a vehicle such as an electric lawnmower may comprise multiple motor controllers. The motor controllers could include deck controllers and drive motor controllers. As software improvements on these motor controllers are made, the updated firmware can be pushed from the cloud, through the cellular network, into the Device, and then to the components that are connected via the serial network. Service technicians will no longer need to be present to make needed software updates to the individual controllers connected to the machine.

All of the vehicle's devices can be monitored and controlled through the present Communication Device via the Cloud, via web access, via the application. So, from the application on your phone (remote device), one can see which devices are turned on, what the devices are doing, whether the vehicle/machine is working (e.g. mowing, or whether the deck controllers are turned on), if the lights are turned on, what the speed is, or anything like that. One can also control any of those devices from the phone. So, since everything is on the CAN Bus, and since it is two-way communication, commands can be sent to the CAN Bus control various devices such as to turn the lights on, to turn the lights off, to adjust the deck height, to move the deck up or down, to adjust the blade speed, adjust the maximum speed of the vehicle, etc. Basically, anything that is on (connected to and/or in communication with) the CAN Bus can be controlled.

It is also a feature of the present invention that it is capable of being connected to off-highway equipment, to allow two-way communication including the receipt of material sensed by the sensors, and the transmitting of orders to the controller of the device that affect the operation of the Communication Device. Such connected off-highway equipment (OHE) can include things such as tractors, excavating equipment, bulldozers, earth movers, forklifts, steamrollers, bricklayers, pavers, graders, spreaders, various agricultural equipment, drone technology, robotics, and other such remote equipment. This feature also has the advantage of enabling the user to monitor the OHE's CAN Bus (or other digital Bus) remotely, be notified of equipment failures or issues instantly, be alerted to any accidents, rollovers, or other potential issues, and to activate or deactivate the vehicle operational components, such as the drive system, motor, and the like.

A further feature of the present invention is that the Communication Device can be coupled to a water-borne vessel or device, such as boat, yacht, PWC, or other watercraft (collectively, watercraft). In addition to those advantages that are provided to the lawn care device, off-road equipment, and OHEs discussed above, the communication device when coupled to a watercraft enables the user to monitor an NMEA 2000 Bus of the watercraft; tie into analog gauges and other devices; be integrated with bilge, fumes, smoke or other sensors to be alerted of potential issues and other problems that the Communication Devices face.

In applications such as Marine Application, any device that is connected to the serial network can be remotely updated through the Device and cloud infrastructure. Devices such as GPS units, Engine Control Computers, Radios, etc. can be remotely updated through the Communication Device of the present invention.

Additionally, the Communication Device, through suitable controllers, can activate and deactivate the vehicle and its accessories to perform such functions such as pre-cooling the boat by turning on the air conditioner prior to the time when the user arrives at the watercraft (e.g. boat); turning the water heater on and off; monitoring battery status; monitoring fuel status; and/or the like.

Electric vehicles use a battery pack that is a fairly large lithium multi-cell battery pack. Through the CAN Bus the Communication Device monitors the battery pack, the individual cell health and voltage, temperature of the cells, temperature of the battery pack, state of charge, and other battery data. Through the phone application, or through the web application, one can constantly see the state of charge—are the batteries charged, did the machine get charged overnight, is the machine charging, are there any problems with the cells, etc. One of the advantages of the present system is from a maintenance point of view and maximizing “up” time, if you will, in that the owner of the machine can see the health of the machine in real time to know whether or not any parts are starting to wear out and anything that needs to be replaced. The system determines deteriorating battery life because batteries do not last forever and, at some point, they need to be replaced. So therefore, the system allows one to be able to monitor battery health.

A further feature of the present invention is that it can be connected to power sports and recreational vehicle products to allow the Communication Device to achieve many of the same advantages as when connected to a watercraft.

All of the above identifications of applications for the present Communication Device can collectively be termed vehicle. It is contemplated that there are, and will be, additional applications not specifically discussed herein.

In an alternate embodiment of the present invention, the Communication Device can be connected to a non-moving item, such as a home of a user, for enabling the remote user to monitor the condition of devices at the home and the status of devices at the home, such as basement water level, basement humidity, garage door open or closed position, power usage, humidity and temperature of the dwelling, thermostatic control, air flow through the house, and other statuses, such as the status of whether the oven and stove are turned on or turned off.

In a most-preferred embodiment of the present invention, the Communication Device is capable of providing device management, analytics and connectivity, and serial bus interface, for vehicles as different as off-highway vehicles, marine vehicles, lawn equipment, automobiles, agricultural equipment, drones, robotics, and process equipment. Preferably, but not necessarily, a 12-channel analog input/output device allows the Communication Device to convert almost any existing device to a connected device.

To reduce cost, the preferred embodiment includes narrow band and/or near field connectivity that connects through global phone technology, and may include direct connection with Bluetooth, and GPS positioning through a GPS device. Further, movement and acceleration sensors can be provided, along with an application placed on the remote device, such as the mobile phone, to control the operation of the device.

In a most-preferred embodiment, the Communication Device has built-in sensors of various types and/or function. A sensor can be provided that automatically alerts various and/or third-party remote-monitoring systems, such as OnStar®. With data provided by the sensors, the Communication Device will be capable to communicate information to a remote user, providing a prediction of the severity of an accident or other problem that the Communication Device may have so that advisors at the remote monitoring system can help make first responders more aware of the possibility of the severity of the action in which the vehicle was involved. This monitoring is especially useful in rollover or accident situations. In stolen vehicle situations, the Communication Device can provide location data about the particular vehicle to thereby help authorities retrieve the vehicle and, possibly, find the person who stole the vehicle.

The Communication Device may also include a GPS sensor to detect GPS position of the machine. There may also be a multi-access IMU (Inertial Measurement Unit) that is monitoring the orientation of the machine in real space, as well as occurrences such as acceleration drops, G-forces, if the machine drives off of a curb it would be detected—information that is sent back to the Cloud. If the machine were to roll over, the occurrence would be detected with the IMU and that information is sent to the Cloud. Vibration on the machine can be detected and send that information back to the Cloud. Other occurrences can be detected and are contemplated.

In a most preferred embodiment, the Communication Device is capable of communicating data to the remote user via the Cloud, and vice versa, which will enable the remote user, through suitable software (e.g. an app), to order correct parts for the Communication Device for those parts and/or components that are reported as breaking down by the Communication Device, provide the user with notifications of when maintenance is due, schedule maintenance with a local dealer or repair shop when appropriate, and provide on-demand diagnostics.

The Cloud communication platform allows different users with different access levels to be able to access the information that is pertinent to them. For example, The cloud based database can be configured to collect and store all of the data that it receives. For the owner of the vehicle, this may be data overload. The owner of the vehicle may only be interested in accessing maintenance information and run time data about his machine. A phone app may be configured to provide this user with dashboard type views of the information that is most important to him. A service tech at the dealer may wish to see more data about how the specific vehicle is being used in order to diagnose problems or resolve warranty issues. For this use, it would be advantageous to configure a PC Based webapp that would allow the technician access to more information.

An additional benefit of the cloud based platform is the ability to interface directly with equipment manufactures existing computer systems. The Cloud Data base can be configured to communicate directly with existing systems such as Oracle/SAP to provide direct data exchange between the two systems.

An additional benefit of the cloud based system is the ability to version control software updates related to the components that are connected to the machine that he Communication device is connected to. The equipment manufacturer can update software for devices connected to their machines at the cloud level. One update to the cloud can then be pushed to hundreds (Or thousands) of machines in the field.

The majority of gas-powered equipment, zero turn mowers for example, do not have a CAN Bus on the machine at all. However, newer fuel-injected engines do. So, with a gas-powered, zero turn machine, with the gasoline engine driving hydraulic transaxles for control of the mower, it likely has a CAN Bus; therefore, the present Communication Device connects to the CAN Bus and get all of the information from the engine. Any adjustments that can be made through the CAN Bus can be made with the present system. Any information that is available on the CAN Bus can be received from the present system. Additionally, the present Communication Device can connect to a number of analog devices, both to control and to receive information. On an analog machine, for example, the present Communication Device could connect to operator sensors, parking brake sensors, neutral sensors, deck on/off switches, and the like. The Communication Device can then transmit the information to the Cloud, which can then be viewed and/or further controlled by the remote user device.

The present Communication Device's analog and digital capability can be configured to send information or to receive information to and from the Cloud. For example, of ten channels of analog, five channels could be receiving information like oil pressure, temperature, battery voltage, etc., while the other five channels can be used to output information, engine kill, or make it so that it cannot start if you're outside a predefined operating area, for example. Deck blades may be turned off in a situation where remotely one needed to for whatever reason. Lights may be monitored and/or controlled such as lights on, display lights, warning lights, dash lights, etc.

The present Communication Device is usable with various outdoor power equipment applications such as ride-on, stand-on, spreaders, aerator devices, and the like. The Cloud may store applications for the various outdoor power equipment that is received and executed by the present Communication Device. A spreader application can connect to a spreader bucket so, for instance, if the spreader is throwing seed or fertilizer, the spreader application via the Communication Device, can monitor and control the rate of seed spreading, overlay that on to a map graph to see where the seed is spread or the area aerated, how much seed was put down, how much time was spent aerating, and/or the like. The rate at which the spreaders broadcast their material is electronically controlled. The rate can be set for various properties and/or areas. That data is stored in the Cloud and then automatically sent to the machine when it is on that particular site. So, he doesn't have to rely on operator of the machine to set the correct feed number for that particular property or area. All is pre-programmed so that when the operator gets out to the property/area, everything is automatic.

These and other features of the invention will become apparent to those skilled in the art upon a review of the drawings and detailed description presented below which represent the best mode of practicing the Invention perceived presently by the applicant.

### BRIEF DESCRIPTION OF THE DRAWINGS

The present invention and its features will be better understood by reference to the accompanying drawings, wherein:

FIG. 1 is a diagram of the overall system;

FIG. 2 is a block diagram of the overall system;

FIG. 2A is a further block diagram of the overall system;

FIG. 3 is a block diagram of a Communication Device of the overall system showing its CPU/Transceiver, modules, accessories, and connections thereof;

FIG. 4A is a perspective view an exemplary lawn mower (vehicle) that includes the Communication Device of the present invention;

FIG. 4B is a schematic view of the Communication Device of the present invention included in the exemplary lawn mower of FIG. 4A;

FIG. 5 is a perspective view of an exemplary truck (vehicle) that includes the Communication Device of the present invention;

FIG. 5A is a representation of the present system utilizing the present Communication Device;

FIG. 5B is a view of components of the truck of FIG. 5 and FIG. 5A that incorporates the present invention;

FIG. 6 is a view of an exemplary typical Recreational Vehicle (RV) that includes the Communication Device of the present invention and showing the overall system of the present invention;

FIG. 6A is a schematic view of the Communication Device on the RV of FIG. 6;

FIG. 7 is a block diagram of the Communication Device on a typical watercraft;

FIGS. 7A and 7B are two schematic views of the Communication Device installed on exemplary machines;

FIG. 8 is a perspective view of the Communication Device;

FIG. 9 is a block diagram of the Communication Device; and

FIG. 10 is a representation of additional modules for the Communication Device.

### DETAILED DESCRIPTION

The Communication Device(s) and system(s) of the present invention are described and shown in the Figures. In the Figures, the following numbers refer to the following parts.
10—User
50—System
100—Example Off-Highway Vehicle
101—Exemplary Vehicle
120—Vehicle Dash
122—Steering Wheel
124—Front Display
126—Vehicle Infotainment Center
150—Exemplary Lawn Mower
152—Lawnmower Engine
200—Exemplary RV Trailer
250—Exemplary Boat
252—Boat Battery
254—NMEA 2000 Connection
300—Exemplary Cloud
310—First Gateway
312—Second Gateway
320—Internet
330—Data Storage and Processing
400—Mobile Smart Device
500—CPU/Transceiver Device
507—Output Wiring
510—CPU/Transceiver Housing
520—CELL MODEM
524—LTE Antenna
522—Optional Blue Tooth Antenna
524—Optional Wi-Fi Antenna
530—GPS Module
532—GPS Antenna
540—IMU Module
542—Voltage Monitor
550—CPU/Transceiver Battery
560—Power Input
562—Voltage Regulator
564—2^{nd} Voltage Regulator
570—CAN Transceiver
580—Microprocessor
590—CAN Connection
592—UART Connection
594—Micro USB Connection
596—Auxiliary I/O
598—LED Indicator Output
599—Switch Input
600—Vehicle Power Connection
610—CAN I/O
620—Memory
630—Bluetooth®
640—Clock
650—Analog I/O
700—Vehicle CAN Connection
720—Vehicle Side CAN Connector
800—Vehicle Analog Connection
900—Optional Module
910C—CAN Cable
920—CAN T
1000—Typical Control Panel
1100—Typical Indicator Gauge (e.g. Water Level)
1102—Typical Indicator Gauge (e.g. Waste Level)
1104—Typical Indicator Gauge (e.g. Fuel Level)
1106—Typical Indicator Gauge (e.g. Voltage)
1202—Typical Switch 1
1204—Typical Switch 2
1206—Typical Switch 3
1208—Typical Switch 4

The present invention is used with vehicles or machines having engines, drive systems and a vehicle bus. By way of non-limiting example, these vehicles may comprise a service fleet that carries-out the business of an enterprise and are each remotely monitored and managed while concurrently dispatched by the enterprise. Such an enterprise might provide certain services via this fleet, such as yard/landscape care (i.e. the fleet includes several lawnmowers or like machinery); delivery of goods; construction, maintenance, repair, and/or renovation of buildings; equipment installation, repair, and/or maintenance (e.g. home appliances, outdoor electric power lines, industrial machinery, communications cabling, in-ground pipelines, etc.); entertainment services where the fleet may comprise off-road vehicles, watercraft, snowmobiles or the like for rent, agricultural machinery (e.g. tractors, harvesters, tillers); and/or over road vehicles, watercraft, and/or aircraft directed to transportation.

In one form, a modular system/platform comprises a device and a system that allows the user to convert a vehicle into a type of connected device capable of wireless two-way communication with a remotely located part via the Cloud. The platform includes, a modular system, a mobile software application and a modular device which contains a CPU and Transceiver and allows two-way remote communication and control from a user's smartphone or other connectable processing device to a vehicle.

In the case of a road vehicle (e.g. car, SUV, truck), the CPU/Transceiver may be at least partly provided with an Engine Control Unit (ECU) or dedicated equipment separate from the ECU. This arrangement enables a party to remotely monitor vehicle location/route and/or speed; determine vehicle maintenance or repair conditions, evaluate vehicle collision/accident status based on one or more on-board inputs (e.g. airbag deployment detection, a rapid deceleration as provided by one or more accelerometers, etc.); temperature of a vehicle passenger compartment and/or a refrigerated cargo space, humidity. Further, it allows the user to control everything from lights, fans, and vents, to AC, pumps, locks. Still further, it allows the Cloud to provide signals to and for operation of the vehicle according to information received from the vehicle.

One implementation interfaces the CPU/Transceiver with vehicle electronic/electrical equipment via a vehicle serial bus that typically is accessed by vehicle electronic equipment with vehicle communication bus, that may be standardized like a Controller Area Network (CAN) Bus type defined by the International Organization for Standardization (ISO) document designated as ISO 11898. Such an arrangement allows true two-way communication between your mobile device and your vehicle from virtually anywhere in the world via the Cloud.

In a most preferred embodiment, the Communication Device includes a CPU and Transceiver (CPU/Transceiver) that can be coupled to a machine, and can sense the state of the machine, and of other peripheral things connected to the Communication Device. The Communication Device can also send electronic communications to the machine, and allows for remote access, control, and updating of electronic things that are part of the machine via the Cloud.

A modem on the Communication Device allows the CPU to transmit and receive data about the device to and from the Cloud. The radio signal from the Communication Device is then connected via wireless radio signal to the Internet. The signal travels through the Internet to a hosting service, and to a second gateway. The second gateway allows for a remotely located user (remote user) to connect via a smart device (such as a mobile phone).

The first and second gateways can comprise things such as cell phone towers, Wi-Fi, hard lines, satellite, wireless radio, or other methods for connecting devices to the Internet. The Cloud may store processing to provide real-time data, commands, signals, uploads, downloads, and the like to the vehicle typically, but not necessarily, in response to vehicle information via the Communication Device.

By way of transition to the remainder of the present application, the present application may provide information to clarify, supplement, define, exemplify, or otherwise advance understanding of certain “terminology” with a “defining description” that may appear in in any order. Potentially, such terminology could be: any word (e.g. compound, blend, portmanteau, acronym, abbreviation, initial word forms), or other symbology (e.g. one or more alphanumeric characters, punctuation marks, mathematical expressions, and/or other marking), alone or in any phrase, character string, concatenation, mixture, multiple, or combination of the foregoing.

The terminology and defining description can be associated in any manner such as: linking/referral language (e.g. a verb with any other word optional); paired punctuation (e.g. (parentheses), ‘single’ or “double” quotes, «guillemets», [brackets], {braces}, -dashes-, etc. . . . ); a single interposed marking e.g. a colon: dash-, ellipsis . . . ; and/or contrasting character pitch, letter case, small caps, etc.

A defining description can specify terminology meaning in any manner, including: direct statement/explanation, delineation of meaning scope/limits, recitation of one or more examples (e.g. a positive/inclusive example type, a negative/exclusive example type, or both), by comparison and/or contrast to other terminology/meanings, etc.; originate new terminology in exercise of a patentee's lexicographic option (e.g. one or more new words, symbols, markings, signs, operators, or combinations of any of the foregoing) with the meaning specified by the defining description.

A defining description can specify an abridgement representative of a longer/fuller form per the defining description (e.g. an abbreviation, acronym, initials, blend or compound word, etc.); specify/identify/represent a value that may be constant or subject to a tolerance or other degree of uncertainty; a mathematical variable with potential to vary as to at least two values either of a numerically quantifiable variety (e.g. either a continuously or a discretely varying numeric value) or a qualitative variety with potential to vary in value non-numerically as to two or more discrete categories (qualitative discrete non-numeric value variation).

Optionally, a defining description can represent a measurable or otherwise quantifiable attribute, trait, quality, property, characteristic, shape, movement, direction, progression, transformation, or the like of any physical or theoretical object, composition, process, application, or the like by mathematical expression, function, variable, approximation, probability/statistical characterization, scalar-based (one-dimensional) or multi-dimensional array (e.g. vector, tensors, matrices, etc. of two or three dimensions, or more) a combination or multiple of any other foregoing; or the like identified with the terminology by equivalence as in Attribute=A, paired punctuation as in Attribute (A), adjacency as in Attribute A, and the like.

Any meaning of terminology defined herein applies in addition to any other meaning of the associated terminology including any ordinary and customary meaning and any meaning as understood by those of ordinary skill in the art pertaining to the patent application to the extent consistent to do so with the meaning defined herein applying as an alternative to any inconsistency. Further, a definition applies to a given occurrence of the terminology without regard to format, any accompanying punctuation, or any difference relative to another occurrence (including occurrence with the defining description) unless explicitly stated to the contrary.

In addition, a terminology definition shall apply to each occurrence of the terminology unless: the defining description of such terminology expressly specifies otherwise or a subsequent defining description differs in one or more respect to redefine the same terminology (a “redefinition”) in which case such redefinition shall apply to any further occurrence of the terminology for the remainder of the present application unless specified otherwise by its defining description or the terminology is subject to further redefinition.

The present application is not all-inclusive or exhaustive—being merely representative and non-exclusively exemplary. From the perspective of those of ordinary skill in the art pertaining to the present application, any patent claim that follows or innovation otherwise described herein can be practiced without one or more details included in the description and/or with one or more additional features, elements, aspects, or the like not recited therein. Any obvious addition, modification, deletion, combination, or other variation of the present application teachings is also within the scope of any properly construed patent claim appended hereto or innovation otherwise described herein. Accordingly, the information provided herewith (including any drawing figure) is not intended to narrow the scope of any patent claim that follows—as compared to the scope of such patent claim defined by the language recited therein when properly construe.

The following description sets forth various details in writing to provide a thorough understanding of the principles and subject matter of the present application including any patent claim that follows and any innovation otherwise described herein. To promote this understanding, the description refers to certain aspects—using specific language to explain the same accompanied by any drawing figures to the extent the subject matter of the present application admits to illustration. If a given aspect of the present application subject matter is well-known, less detail about such given aspect may be presented by way of illustration, writing, or both as compared to any aspect that is unknown (or at least not as well-known) to sharpen clarity of this description. This description and any attendant drawing figures present the subject matter of the present application by way of one or more examples, forms, instances, or the like; and sometimes includes one or more alternatives, modifications, or variants of the same—but the description is not intended to be all-inclusive.

Instead, it is merely representative and exemplary. Accordingly, the description sets forth representative examples only and does not constrict, limit, restrict, reduce, restrain, or otherwise narrow the coverage/scope of any patent claim that follows nor that of any innovation otherwise described herein.

The present invention allows a user to embrace the 4^{th} industrial revolution and take advantage of the digital transformation. The platform approach of the present invention allows a business to navigate the technologies that are available and find ways for a business and product users to gain useful data and increased revenue with the right connected device strategy. The present platform provides an organization with a jump start in the connected device arena. The CPU/Transceiver design of the present Communication Device un-complicates the connected device arena and helps to take the guess work out of machine-to-machine and IoT connectivity, management and security by creating an integrated eco-system accessible through RESTFul APIs.

The present invention takes advantage of the opportunities that the digital transformation has presented by helping users quickly, and efficiently take their products and machines to the next level. By turning the machines, vehicles and devices (collectively machines) into connected devices, the user will be able to collect data in ways that were never before possible. Among the data that can be collected are data about how the machines are being used, how much fuel is being consumed, how much vibration they experience, what actual forces are being experienced by the operator on a per use basis. Additionally, information can be obtained relating to whether the machines are being run efficiently, how much fuel is used per job site, how would switching to full electric impact the operation, and the costs of running full electric.

This data will allow the user to improve the next generation of products, decrease warranty issues, and create products that will be the best ever created for the user.

Connected devices will give customers the opportunity to save money and increase efficiency by automating reporting. Customers may be able to take advantage of automating regulatory reporting based on their connected device usage and even be set up to link directly to existing systems such as billing and scheduling software.

The connected devices of the present invention will allow real-time maintenance monitoring and notifications to become a reality. The connected device can transmit use data directly to the Cloud where advanced algorithms can calculate when maintenance is required based on the actual use of the connected device. Increased time between failures, and decreased downtime will translate directly into increased revenue for the users. No more guessing at maintenance or basing maintenance on a date. The connected device will tell you when it needs maintenance.

Once the use data has been collected from the connected device, the data can be used in creative ways. The user can employ the data to predict failures by integrating AI based systems to analyze the data and start making predictions. Other uses for the data exist. For example, one can compare use data to weather data to find out how the connected device performs based on the weather. One can compare the connected device use data to the price of fuel, or use data can be combined with geographical data, compared with economic data, compared with political data. Once we have the data available, the possibilities are endless.

Fleet Tracking exists, but with the increased proliferation of IoT devices the capability is now a reality for your connected device. The users and employees will know exactly where the connected mower is, and how it is being used at any time.

One of the concerns that dealers all seem to have is that they are losing sales of their devices, sales of maintenance and repair parts, and sales of services to online retailers. Users of the machines are ordering more of their parts from online sources and doing more of their maintenance outside of dealer networks. By creating the connection to the device and to the end user, the OEM's and the dealers will have direct access to the end user or the manager of the equipment. This can be tied in with the maintenance tracking, and predictive maintenance. Under the present invention when a connected device is in need of maintenance, it can notify both the user and the dealer. The notification may include a direct link to the dealer or parts ordering or a direct link to the dealer to schedule service. A savvy dealer may even create a loaner program that would allow at the dealer to drop of a loaner machine while they pick up the user's connected device for maintenance.

Accidents occur with many machines, and sometimes they are unavoidable, but there are ways that the IoT (Internet of Things) technologies of the present invention can help. The Platform can detect what it is doing, what the connected machine is doing, and where it is located. It also will know if it the device has experienced a severe impact, has had a roll over event or has flipped. This information can be used to trigger emergency calls or a request for help. A panic button feature could also be added to allow the user to request assistance in an emergency situation.

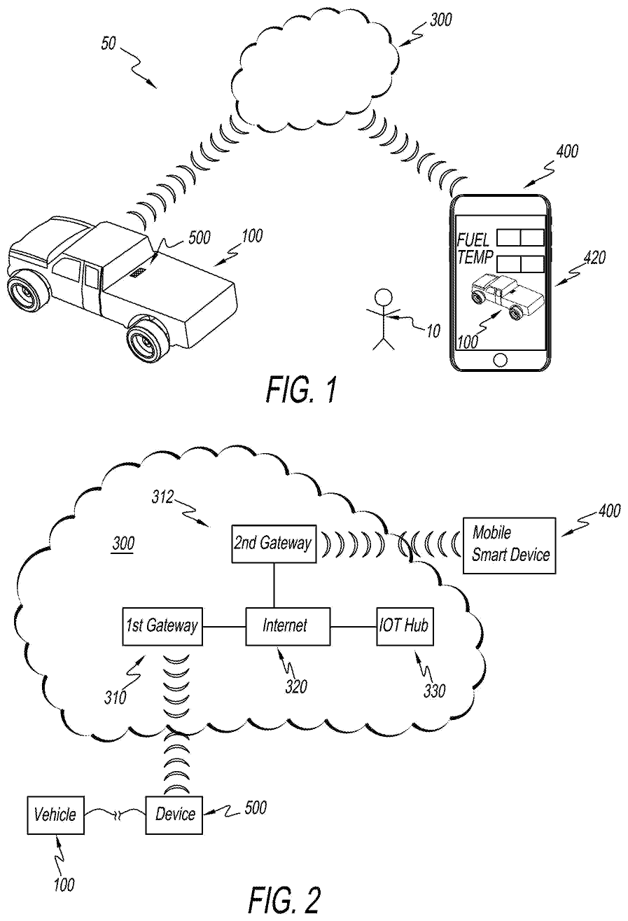

Turning now to FIG. 1 we will see a representation of the complete system, generally designated 50. The complete system 50 consists of a Communication Device or CPU/Transceiver (collectively and interchangeably) 500, which is connected to some type of machine such as an off-highway vehicle 100. The Communication Device 500 sends and receives data and commands wirelessly through an Internet of Things (IOT) Cloud Connection 300. A user 10 is able to interact with the vehicle 100 by accessing the Cloud based IoT hub 300 through a mobile device 400 application or app (Mobile App) 420 on a user's remote smart device (e.g., a smartphone). The connected off-highway vehicle 100 when connected to the Communication Device 500, allows two way communication to and from a smartphone 400 only via the Cloud 300. It also allows communication from the Cloud to the connected off-highway vehicle 100. The Communication Device 500 is in constant communication with the Cloud 300. The Cloud 300 directly sends messages/data to the Communication Device 500 of the connected off-highway vehicle (machine) 100. There is no direct connection between the Communication Device 500 and the user's remote device. Therefore, the user's remote device does not control the connected machine, the Cloud does. Smart functionality for the connected machine is programmed into the Cloud 300. The Cloud stores information regarding operation of the Communication Device and/or connected vehicle.

The frequency at which data regarding the vehicle is sent to and from the Cloud may be regulated. With Bluetooth®, the vehicle may be controlled directly by a user's Bluetooth® enabled device that is near the vehicle. Such functions as a vehicle's dashboard may thus be controlled in real time directly without the Cloud interface. The Communication Device 500 can thus control the amount of data that is sent to the Cloud. Such parameters may be stored in the Cloud and provided to the vehicle as desired. Updates of programming and the like for the vehicle/Communication Device may be sent from the Cloud to the Communication Device based on the state of the vehicle or machine according to data regarding the vehicle/machine. Because the Communication Device 500 uses a cell phone connection, data plans may be necessary or required. Frequency of updates/communications between the vehicle/machine and the Cloud may thus be controlled based on the type of cell phone plan and/or use (e.g. residential plan/use or commercial plan/use).

Turning now to FIG. 3, the Communication Device 500 with its CPU/Transceiver module and its connections is shown. The Communication Device 500 has a GPS module 530 that allows the user 10 to access location of the vehicle 100 with the user's remote smart device 400. The user 10 will use the Mobile App 420 of the present system 50 on the mobile device 400 to access the Cloud 300 and retrieve position data from the Global Positioning Satellite (GPS) module 530.

The user 10 will also be able to retrieve and send commands to the vehicle's CAN (or similar) Bus through the remote smart device 400 mobile app 420. Failures of components or component errors transmitted to the CAN Bus can be sent to the Cloud 300 via the CAN Bus from the Communication Device 500 and accordingly to the mobile phone 400 of user 10. If an optional IMU sensor/module 540 is used, an alert can be sent to the remote mobile smart device user 10 to alert the remote mobile smart device user of any vehicle roll overs or the like.

Remote programming or re-programming of the CAN Bus is possible through the Communication Device 500 connection and its interface with the vehicle 100. Auxiliary components of the vehicle 100 (or other machines) can be activated or deactivated remotely. Maintenance reminders and/or other diagnostic information can be sent from the machine 100 to the Cloud 300 through the Communication Device 500. Programming may also be accomplished via a laptop or other device through an appropriate interface of the Communication Device 500.

The Cloud 300 may store data/information for the connected machine. In conjunction with data from the Communication Device 500 the connected machine may, without limitation, be controlled from the Cloud for functions such as geo-fencing, duration of machine use, operation time(s), number of jobs (times a connected vehicle may be used in a particular period), or the like.

The Communication Device 500 has a reporting function that sends vehicle/machine data to the Cloud based on frequency, status of the vehicle/machine (e.g. power is off/on, vehicle/machine is moving, battery status), or the like.

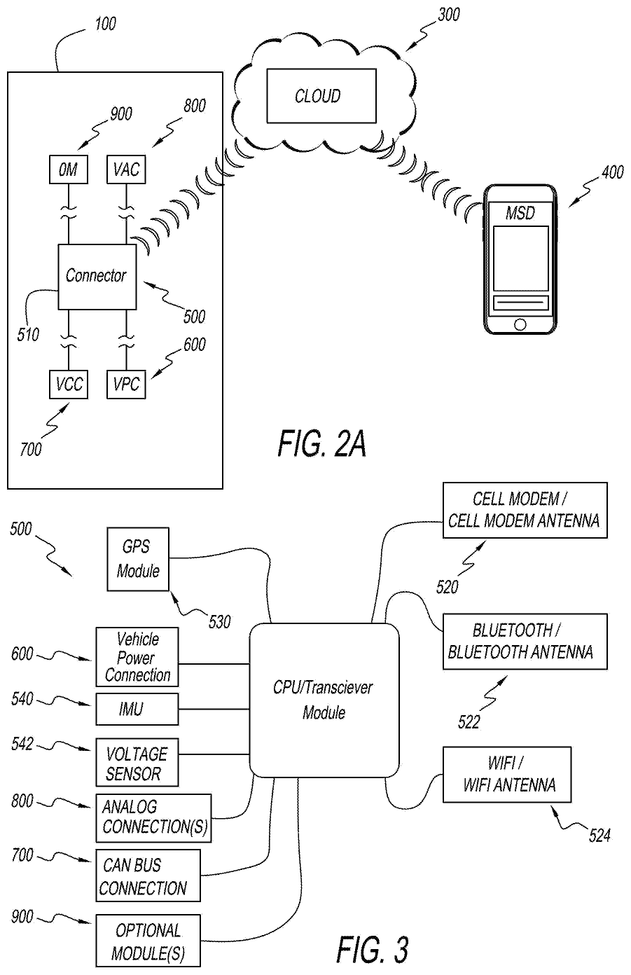

Smart algorithms running on the IoT Hub 300, and AI Based Machine Learning, can be used to predict failures, and allow the user 10 to perform predictive maintenance on the connected machine 100 before problems occur. Turning now to FIG. 2, you will see a block diagram of an exemplary IoT Cloud Hub 300 for communication to and with the Cloud. The IoT Cloud Hub 300 (or collectively, the Cloud) comprises a gateway 310 connecting the wireless connector to the Internet 320. The Gateway 310 can consist of a Bluetooth® (near-field) connection, a Wi-Fi connection, a cell phone connection, a satellite phone connection, or other type of connection.

A preferred embodiment of the invention includes a cell gateway connection. The internet 320 is then connected to the Internet of Things (IoT) hub 330. The Communication Device 500 is in wireless communication with the Gateway 310. The Gateway 310 is then connected either wirelessly or through hardwire to the internet 320. The internet is in electronic communication with the IoT hub 330. A remote mobile smart device (MSD) 400 is in connection with a second gateway 312. The second gateway is in connection with the internet 320.

In this preferred embodiment, the Communication Device 500 communicates information to and from the connected machine 100 to and from the gateway 310, through the internet 320, to and from the IoT hub 330. The Mobile Device 400 Communicates information and commands to and from the second gateway 312 to the internet 320 to and from the IoT hub 330. This allows the mobile device 400 to be in communication with the Communication Device 500 and the connected machine 100. This configuration also allows the Cloud to provide data, signals, commands, programming, re-programming, etc. to the Connected Vehicle (machine) 100 and its components via the vehicle's CAN Bus.

Turning now to FIG. 2A you will see a block diagram of an exemplary form of the system 50. The mobile smart device 400 may be, but is not limited to, a laptop, phone, tablet or the like 400 that is in communication with the Cloud 300. The Cloud 300 is in communication with the Communication Device 500 within the housing 510. The Communication Device 500 is connected to a plurality of vehicle connections comprising such things as, but not limited to, Vehicle Power Connection 600, Vehicle CAN Connection 700, Vehicle Analog Connections 800, and Optional Modules 900.

Optional Modules 900 may comprise Inertial Measurement Units (IMUs), temperature sensors, humidity sensors, voltage sensors, video sensors and otherwise, both active and passive, analog or digital.

Turning now to FIG. 3 you will see a block diagram of the components of the Communication Device 500. The Communication Device components may comprise, but is not limited to a cell antenna/cell modem/transceiver 520, Bluetooth®/Bluetooth® antenna 522 (or other near-field wireless protocol), Wi-Fi/Wi-Fi antenna 524, GPS 530, Inertial Measurement Unit (IMU) 540, voltage senor 542, a plurality of analog and serial Connections 800, CAN Bus Connection 700, and an expandable port for future modules 900.

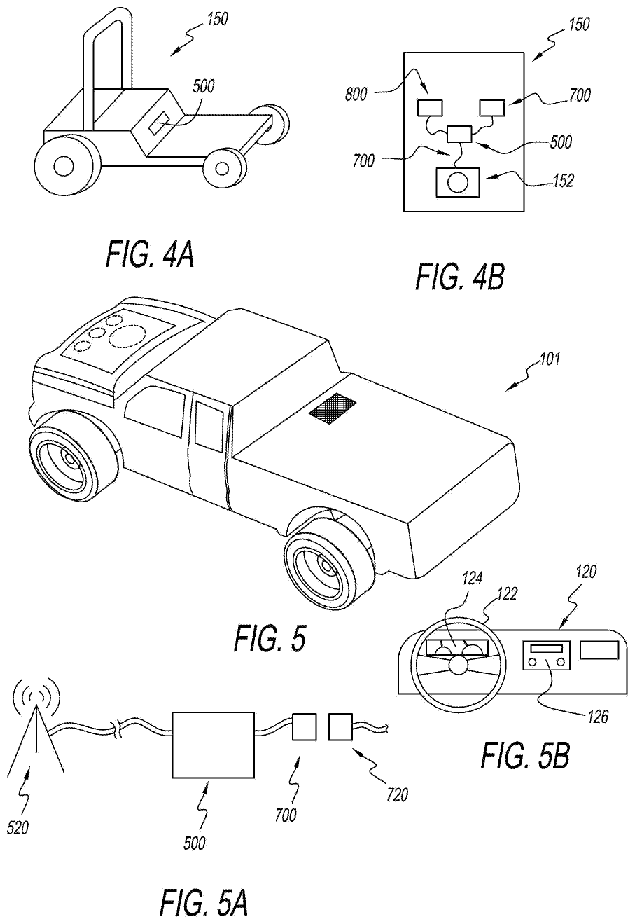

FIGS. 4A and 4B show a perspective view and a top view, respectively, of an exemplary lawn mower 150 with the Communication Device 500 installed thereon. The lawn mower 150 includes a lawn mower engine 152. The lawn mower engine 152 is connected to the Communication Device 500 via a CAN BUS connection 700. The Communication Device 500 is also connected via the mutual CAN Bus to lawn mower digital components and via analog connection 800 to lawn mower analog components.

FIG. 5 shows an exemplary on-road vehicle 101 installed with a Communication Device 500. FIG. 5A shows a basic installation of the Communication Device 500 connected to the Vehicle 101 through the Vehicle's CAN Bus Connection 720. In this installation, the Communication Device 500 is powered from the vehicle 100's Can Bus 720 via the Device's CAN Bus 700. The Communication Device 500 is connected to the Cloud 300 through the Communication Device 500's internal Cell module and antenna 520. FIG. 5B shows a dashboard 120 of the vehicle 101. The vehicle 101 has a steering wheel 122, vehicle dash information 124, and a vehicle infotainment center 126, all of which are connected to the CAN Bus and/or analog connections.

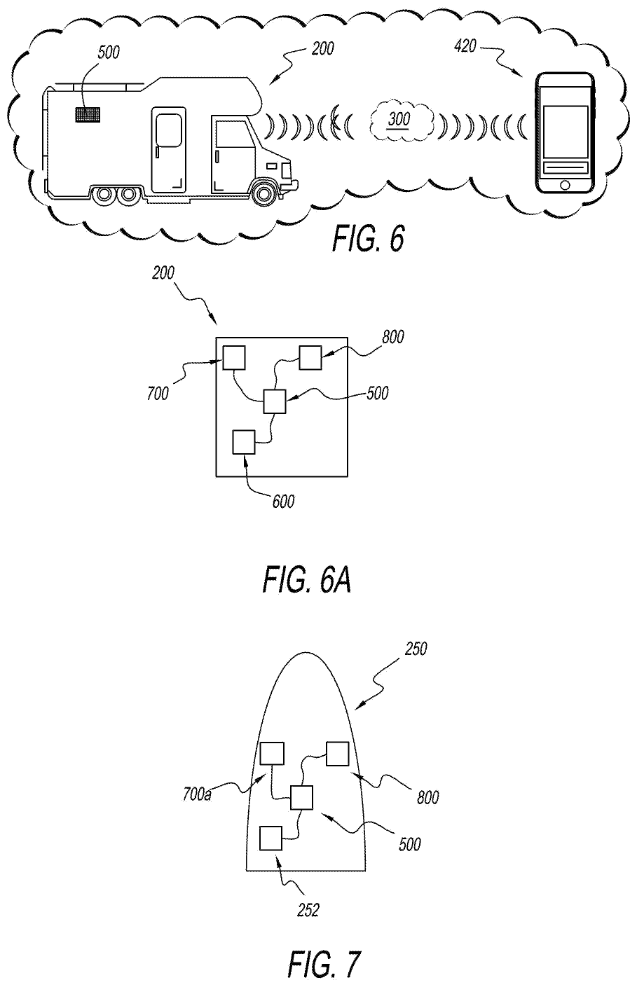

FIGS. 6 and 6A show two schematic views of an exemplary Recreational Vehicle (RV) 200 Connected to the Cloud 300 by the present Communication Device 500. In this configuration, the object of the present invention can interface with various devices and sensors on the RV 200. The Communication Device 500 is shown connected to power 600 and to analog components of the RV 200 via the analog connection 800. If so equipped, the Communication Device 500 interfaces with the CAN Bus 700 of the RV 200.

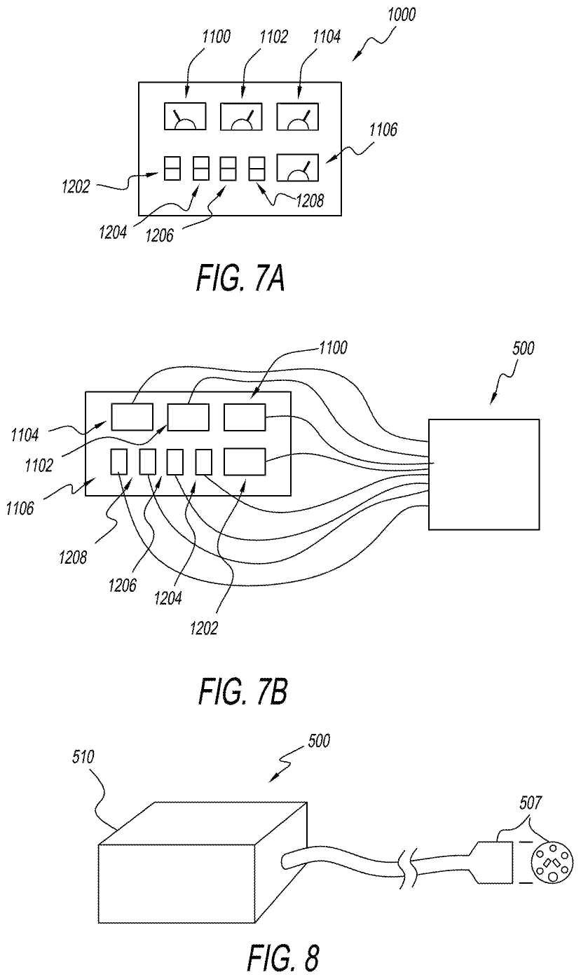

FIG. 7 shows a schematic view of an exemplary boat or yacht 250 with the present Communication Device 500, the boat/yacht 250 being representative of all types of watercraft. The Communication Device 500 is connected to power 252 (e.g. the watercraft's battery), analog Connections 800, and NMEA 2000 Bus Connection (and/or other Bus Connections) of the watercraft 250. FIGS. 7A and 7B show a front and rear view of a typical control panel 1000 that would be found in a typical yacht 250 or RV 200. The exemplary electrical control panel 1000 comprises a plurality of gauges 1000, 1102, 1104, 1106, and a plurality of switches 1202, 1204, 1206, 1208. The gauges can be gauges connected to sensors that measure things like tank levels, fuel tank levels, water tank levels, gray water tank levels, voltage, current, or many other measurable parameters. The switches typically comprise on/off switches for electrically controlled devices like pumps, motors, vents, door or hatch openers, fans, and other devices.

Each of the gauges 1102 (and here, their sensors) can be electronically connected to the Communication Device 500. The electronic connection allows the Communication Device 500 to monitor the electrical signal that the sensor sends to the gauge, and transmit that signal to the Cloud 300.

Each of the switches 1202 can be electronically connected to the Communication Device 500. The switches 1202 can be wired to the Communication Device 500 to allow the Communication Device to monitor the position of the switch, or can be wired to control the action output of the switch. In this configuration the Communication Device 500 can be used for remote monitoring and control of systems that are on the RV 200.

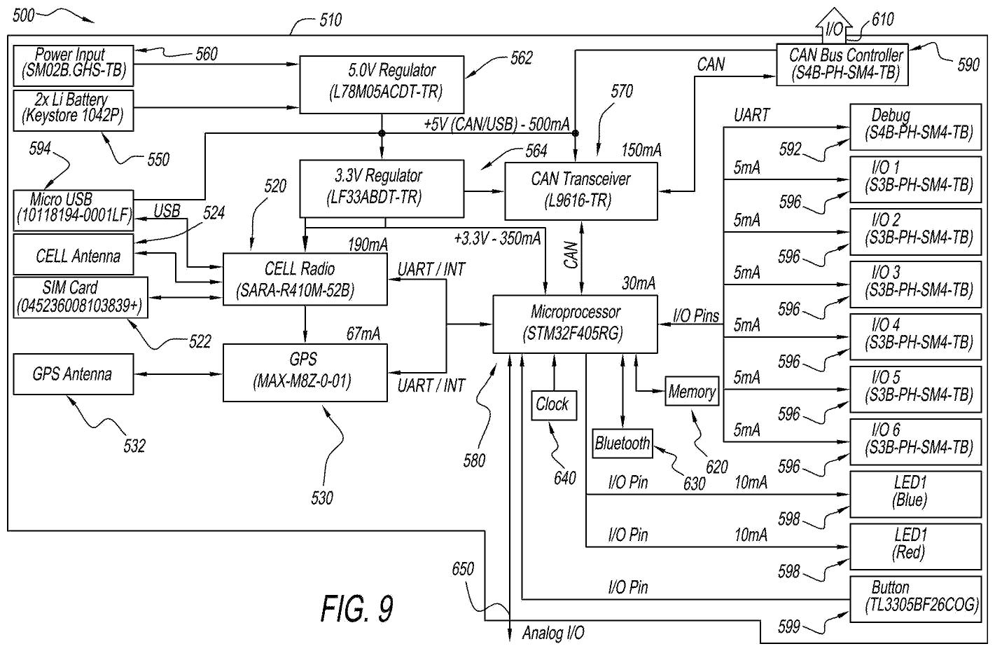

FIG. 8 shows an arrangement of the Communication Device of the present invention. The Communication Device 500 has a housing 510 and a multi-pin CAN Bus connector 507 that is configured to attach to a CAN Bus connector of the machine (not shown). In one form, the housing 510 is plastic and includes the circuit board, antennas, connectors, batteries, and other items necessary, as described herein, and/or as shown in FIG. 9 and others in order to carry out the functionality shown and described herein. The housing 510 may be water resistant or water-proof depending on its application/environment. One or more, or all of the components within the housing 510 may be potted or not. Wire leads of the various internal housing components extend from internal the housing 510. The primary wire going out includes a CAN Bus cable with CAN high, CAN low, battery positive, battery negative, and wires connected to analog components of the Communication Device 500. The Communication Device 500 operates from the battery of the connected vehicle. A battery separate from the battery of the connected vehicle may be provided that may run a clock or provide other functions on a printed circuit board of the Communication Device 500. The circuit board or boards contain a CAN controller, an analog controller, a microprocessor, memory, cellular module, a power regulator, an onboard battery to keep components awake if the Communication Device is disconnected from power, a clock, a GPS module, a preferably, but not necessarily, 9-axis sensor IMU. The nine axis IMU provides a 3-axis gyroscope, a 3-axis accelerometer, and a 3-axis compass. The memory can be any type of memory such as, but not necessarily, an SD card, flash memory, or the like.

The GPS antenna 532 and cellular antenna 524 may be incorporated into or onto the housing 510, or they can be mounted remotely. Remote mounting may be necessary depending on the application and the location of the Communication Device 500 to ensure that there is a good wireless radio signal from the GPS satellites and to and from the cellular antenna.

FIG. 9 shows a block diagram of the components of the present invention, including the GPS antenna 532 and the cellular antenna 524. In a preferred embodiment, these components are configured to be located on a single electronic board. In an alternate embodiment, the components may be on separate circuit boards.

A microprocessor or processor 580 (such as, but not limited to, an STM32F405RG) is in electronic communication with a cellular (cell) radio/cell module 520 (such as, but not limited to, a SARA-R410M-52B or NIMBELINK™) that is connected to the cell antenna 524. The cell radio 520 is in communication with a USB interface/port 594 or similar (such as, but not limited to, a micro USB interface/port 10118194-0001LF) and a SIM card interface/port (such as, but not limited to, a 045236008103839+) for a SIM card. The SIM card provides a unique ID on the cell network. The microprocessor 580 sends electronic signals to the cellular radio/cell module 520. The cellular radio 520 converts the electrical signal into a packet of information that can be transmitted wirelessly through the cellular network and to the IoT Hub 300—and thereafter to the remote user device 400, and vice versa. The microprocessor 580 may also be connected to a Bluetooth® module (or other near-field communication device/protocol) 630 for connection to and with Bluetooth® enabled devices. With Bluetooth® a user may use a Bluetooth® enabled smart phone or other Bluetooth® enabled device as a dashboard for the connected vehicle to allow direct connection to and from the connected vehicle without going through the Cloud.

Information for and regarding a connected vehicle is preferably, but not necessarily, stored in the Cloud and provided to the Communication Device 500 associated with the connected vehicle.

The microprocessor 580 is also connected to a plurality of inputs and sensors. In the embodiment shown, the microprocessor 580 is in electronic communication with the GPS module 530 (such as, but not limited to, an MAX-M8Z-0-01) that is connected to the GPS antenna 532, a CAN transceiver 570 (such as, but not limited to, an L9616-TR) that is in communication with a CAN Bus interface/port 590 (such as, but not limited to, an S4B-PH-SM4-TB), a plurality of configurable Input/output connections 596, a plurality of indicator LED lights 598, and at least one button (such as, but not limited to, a TL3305BF26COG). Memory 620 is provided for program/programming storage for real-time programming/re-programming, and microprocessor 580 use. A clock/clock chip 640 may be provided in addition to any clock of the microprocessor 580. A CAN Bus Input/Output (I/O) interface 610 is provided to allow connection to the vehicle's CAN Bus (e.g. CAN Hi, CAN Low, V+, V−). Additionally, an analog I/O interface 650 is provided to allow connection to the vehicle's analog components. The CAN Bus I/O 610 and the analog I/O 650 may be combined in a single wire out bundle/connection/connector.

The microprocessor 580 contains embedded software that communicates with the components of the connected vehicle. The microprocessor 580 pulls data from the connected components of the vehicle. It takes information from the Cloud back to the microprocessor and sends information out to the Cloud or other place. Most decisions for the connected vehicle are made in the Cloud and transmitted to the Communication Device 500. However, some decisions are done on-board. In essence, the microprocessor 580 handles the communication between the cell phone module and all of the various components on the board without performing too much processing, allowing more complicated processing to be performed in the Cloud.

Electrical Power is supplied to the microprocessor and to the peripheral and other components from a plurality of voltage regulators. In the embodiment shown (FIG. 9), a first regulator 562 is used to convert vehicle level power to 5 v, and a second regulator 564 is used to convert the 5 v power to board level 3.3 v power. In a preferred embodiment, one or more lithium ion batteries 550 are included to provide backup power. External power is obtained from the vehicle from a power connection 560. It should be appreciated that the schematic of FIG. 9 may not necessarily show all connections or data pathways necessary for the Device 500 to operate.

It is desirable to have a system that allows users to add upgrade in the future. When new technologies and devices are released, it is desirable to be able to easily add them to the present invention.

“Plug-and-play” functionality is desirable, and is achieved in the object of the present invention by allowing modules to be expanded via the serial connections of the board, and future software updates to be transmitted to the object of the present invention over the cellular network.

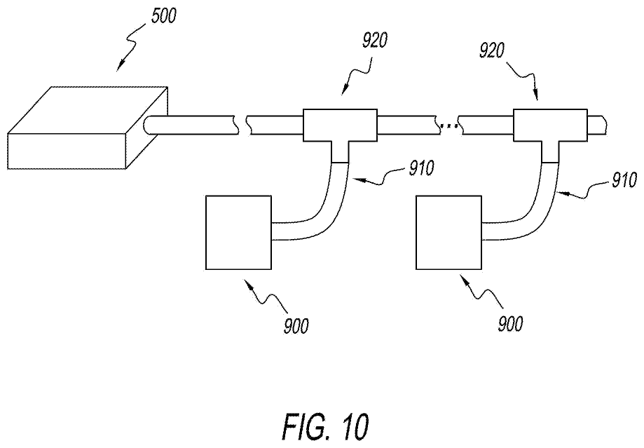

FIG. 10 illustrates how additional modules 900 can be connected to the main CPU/Transceiver (Communication Device) 500 via serial bus. In one embodiment, additional modules 900 are connected through CAN Bus cables 910 from CAN Bus Ts 920.

Expansion modules 900 may comprise modules such as GPS modules, additional sensor modules, autonomous modules, motor control modules, vision sensor modules, and others. In a preferred embodiment, additional modules 900 are added to the Communication Device 500 by electrically connecting through the CAN Bus via a plurality of CAN Bus Ts 920 to add a plurality of modules 900.

Any conjecture, discovery, experiment, estimation, finding, guesswork, hypothesis, idealization, investigation, model, operating principle or mechanism, prophetic description, representation, speculation, theory, test, test or experimental results, or the like relating to any aspect of the present application is provided to enhance understanding of the subject matter thereof without restricting any patent claim that follows-except to the extent the foregoing is expressly and unambiguously recited in such patent claims. The organization of application content under one or more headings aims to enhance understanding of such content and promote application readability, but these headings are not intended to affect the scope, meaning, substance, or “prior art” status of such content, except to the extent (if any) unambiguously expressed to the contrary in connection with each specific instance thereof.

No patent claim hereof or innovation otherwise described herein should be understood to include a clause with a “means for” or “step for” performing a function (e.g., means plus function clause or step plus function clause, respectively), unless expressly specified by reciting within such clause “means for . . . ” or “step for . . . ” followed in close proximity by a function in gerund (“-ing”) form. Except to the extent expressly indicated to the contrary, aspects recited in a process or method claim (such “aspects” collectively refer to any acts, actions, activities, clauses, conditions, conditionals, contingencies, elements, events, features, gerunds, limitations, operations, phases, phrases, stages, statements, steps, relationships, or the like) may be performed in any order or sequence irrespective of cardinality or otherwise.

Furthermore, any two or more of such aspects may be performed simultaneously, concurrently, or overlapping in time. Indeed, no order, sequence, concurrence, simultaneity, or overlap of two or more of such aspects results just because the process or method claim: (a) recites one of these aspects before another within the claim language, (b) precedes the first occurrence of an aspect with an indefinite article (“a” or “an”) or no article (as is commonplace for a plural noun, a proper noun, a mass or uncountable noun, an abstract noun, a number, a noun followed by a number, an prepositions, any, all, some, many, several, another, each, and certain other types of terminology in the English language) followed by a one or more subsequent occurrences of such aspect preceded by a definite article (“the” or “said”), (c) ordinal numbers in word form (first, second, third, . . . ) each precede the same identifier, descriptor, item, or the like to distinguish between them (e.g., first device, second device, third device, . . . ; first one of the modules, second one of the modules, third one of the modules, . . . ; or the like), or (d) the process/method claim includes alphabetical or cardinal number labeling to improve readability, organization, or the like—except to the extent the content of such claim properly construed unambiguously imposes a particular order, sequence, concurrence, simultaneity, or overlap as to two or more of its aspects.

To the extent a particular order, sequence, concurrence, simultaneity, or overlap is imposed as to certain aspects of a process/method claim, but not all aspects of such claim, the same does not impose any order, sequence, concurrence, simultaneity, or overlap as to any other aspect listed before, after, or between such certain aspects.

The subject matter of the foregoing description and any drawing figures of the present application is not all-inclusive or exhaustive—being merely representative and non-exclusively exemplary. With respect to any patent claim that follows or innovation otherwise described herein, those of ordinary skill in the art pertaining to the present application will recognize that the same can be practiced without one or more details included in the description; and will also recognize such innovation or patent claim can be practiced with one or more additional features, elements, aspects, or the like not recited therein.

Further, any obvious alteration, modification, or variation that may result from the present application teachings is also within the scope of any properly construed patent claim appended hereto or innovation otherwise described. Accordingly, the information provided in the preceding writing and/or any accompanying drawing figure is not intended to constrict, limit, restrict, reduce, restrain, or otherwise narrow the scope of any patent claim that follows—as compared to the scope of such patent claim defined by the language recited therein when properly construed.

Presented below are some examples of the use of the present invention and the features it can provide.
Example 1: Lawn Equipment. When connected to Lawn Equipment, the platform of the present invention allows two-way communication from your smartphone to your powered lawn equipment anywhere in the world. You can not only know the location and current status of the connected device, but you can also have full communication with the vehicle. You can monitor the CAN bus remotely. Be notified of equipment failures or issues instantly. Be alerted to any accidents, roll overs, or other potential issues. Activate and deactivate the vehicle or accessories on the vehicle. Maintenance reminders may be provided.
Example 2: Off Highway Equipment. When connected to Off Highway Equipment, the present invention allows two-way communication from your smartphone to your tractors, excavating, or virtually any other outdoor connected device power equipment anywhere in the world. You can not only know the location and current status of the piece of equipment, but you can also have full communication with the vehicle. You can monitor the CAN bus remotely. Be notified of equipment failures or issues instantly. Be alerted to any accidents, roll overs, or other potential issues. Activate and deactivate the vehicle or accessories on the vehicle. Maintenance reminders may be provided.
Example 3: Watercraft. When the present invention is connected to Boats, Yachts, or other watercraft, you can not only know the location and current status of the boat, but you can also have full communication with the vehicle. You can monitor the NMEA 2000 Bus remotely. Tie into analog gauges and other devices if desired. Be notified of failures or problems instantly. Integrate with bilge, fumes, smoke, or other sensors to be alerted of potential issues. Activate and deactivate the vehicle or accessories on the boat. Pre-cool the AC. Turn off the water heater. Monitor battery and fuel status. Maintenance reminders may be provided.
Example 4: Power Sports Equipment. When the present invention is connected to Power Sports equipment such as motorcycles, side-by-sides, quads, or recreational vehicle products such as campers, RVs, and trailers, you can not only know the location and current status of the vehicle, but you can also have full communication with the vehicle. You can monitor the NMEA 2000 Bus remotely. Tie into analog gauges and other devices if desired. Be notified of failures or of problems instantly. Integrate with bilge, fumes, smoke, or other sensors to be alerted of potential issues. Activate and deactivate the vehicle or accessories on the Power Sports Equipment. Pre-cool the AC. Turn off the water heater. Monitor battery and fuel status. Maintenance reminders may be provided.
Example 5: Process Monitoring and Control Equipment. The present invention can also be connected to process monitoring and control equipment such as a connected brewery, a connected chemical production facility, a connected paint production facility, or a connected pharmaceutical processing facility.
Example 6: Home Appliances and Devices. Further, the present invention platform can be used with monitorable and or operable home devices such as home or commercial basement or floor water level, basement or floor humidity, garage door open/close, power usage, temperature, thermostat control, airflow, or remote thermostats (e.g. multi-thermostats). No Wi-Fi or internet may be required.
Example 7: Exemplary Components of the present invention include platform, device management, analytics, and connectivity (from a price per month). It further provides a serial bus interface, for off-highway vehicles—SAE J1939 and CAN Open, for marine—NMEA 2000. It moreover is useable for mowers, automotive, robotics, and process equipment. It provides 12 channel analog I/O allowing the present Communication Device/Connector to convert almost any existing device to a connected device; has narrow band connectivity for low cost cell connectivity; may have direct connect with optional Bluetooth (near-field communication); may have optional GPS positioning; and may have optional movement and acceleration sensor(s). There may be a custom app. Connectivity of the Platform provides SIM based cell connectivity and satellite as an option.
Example 8: Exemplary (Optional) Functions and Tasks Performed by the present Communication Device include built-in sensors to automatically alert a connected Advisor. With injury severity prediction, Advisors can help make first responders aware of the possible severity of the crash and injuries or may provide stolen vehicle assistance (pinpoint location of missing asset and work with authorities) and vehicle diagnostics (monitor vehicle's operating systems and provides regular updates about the vehicle's health. The Device may allow the mobile app to order correct parts, provide maintenance notifications when maintenance is due and/or schedule maintenance with local dealer. The present Communication Device ca also provide on-demand diagnostics such as to trouble shoot and/or monitor CAN enabled devices on the machine remotely. Boundary alerts may be provided to advise of vehicle location at all times.
Example 9: Use Cases for Data Transfer include allowing for two-way communication from the remote user's smartphone to a powered machine (e.g. lawn equipment device) anywhere in the world. How often is data sent to and from the Communication Device depends on amount of data and use. A user can not only know the location and current status of the piece of equipment, but the user can also have full communication with the vehicle. A user can monitor the CAN Bus remotely to send data when a flagged event occurs, send specific data at specific time interval (e.g. Battery Status), see when using (1 min/5 Min/10 Min), see when charging (1 min/5 Min/10 Min), detect problem(s). A user may receive notification of equipment failures or issues instantly, receive alerts of any accidents, roll overs, or other potential issues, instantly send data, activate and deactivate the vehicle or accessories on the vehicle, and command hardware when request received. Diagnostics may provide sending data based on run time, sending data when requested, sending data if flagged issue occurs.
Example 10. Smart Shopping Cart
Example 11: Cloud to Machine firmware update of electronic components that are connected to the Communication Device.

While the invention has been illustrated and described in detail in the drawings and foregoing description, the same is to be considered as illustrative and not restrictive in character, it being understood that only preferred embodiments have been shown and described, and that all changes and modifications that come within the spirit of the invention are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention.

What is claimed is:

1. A communication system for a vehicle comprising:
a communication device associated with the vehicle, the communication device having a processor, memory in communication with the processor, a cellular transceiver in communication with the processor, a cellular antenna connected to the cellular transceiver, a GPS receiver in communication with the processor, a GPS antenna connected to the GPS receiver, a CAN Bus interface in communication with the processor and configured to allow connection to a CAN Bus of the vehicle, the processor configured to 1) receive data regarding the vehicle from the CAN Bus of the vehicle via the Can Bus interface and send the received data regarding the vehicle to only the Cloud via the cell phone transceiver, 2) receive data for the vehicle from only the Cloud, and 3) control the vehicle according to the received data for the vehicle utilizing the CAN Bus of the vehicle; and
an application configured to operate on a remote device of a user, the application allowing reception of data regarding the vehicle from only the Cloud and transmission of data regarding the vehicle to only the Cloud for transmission to the vehicle.

2. The communication system of claim 1, wherein the communication device further comprises an analog interface in communication with the processor and configured to connect to analog components of the vehicle.

3. The communication system of claim 2, wherein the communication device further comprises an IMU in communication with the processor.

4. The communication system of claim 3, wherein the remote device of a user comprises a smart phone.

5. The communication system of claim 3, wherein the communication device further comprises a near-field communication module in communication with the processor.

6. A communication device for a means of conveyance comprising:
a processor;
a cellular transceiver in communication with the processor;
a cellular antenna connected to the cell phone transceiver;
a GPS receiver in communication with the processor;
a GPS antenna connected to the GPS receiver; and
a CAN Bus interface in communication with the processor and configured to allow connection to a CAN Bus of the means of conveyance;
the processor having programming configured to 1) receive data regarding aspects of the means of conveyance from the CAN Bus of the means of conveyance via the Can Bus interface, 2) send the received data regarding aspects of the means of conveyance to only the Cloud via the cell phone transceiver, 3) receive data for the means of conveyance from only the Cloud, 4) control aspects of the means of conveyance according to the received data for the means of conveyance from only the Cloud utilizing the CAN Bus of the means of conveyance, 5) send data regarding aspects of the means of conveyance to a remote device of a user via only the Cloud, and 6) receive data regarding aspects of the means of conveyance from only the Cloud through data received by the Cloud from a remote device of a user.

7. The communication device for a means of conveyance of claim 6, wherein the means of conveyance comprises one of a vehicle and a watercraft.

8. The communication device for a means of conveyance of claim 6, further comprising an analog interface in communication with the processor, and configured to connect to analog components of the vehicle.

9. The communication device for a means of conveyance of claim 8, further comprising an IMU in communication with the processor.

10. The communication device for a means of conveyance of claim 9, wherein the remote device of a user comprises a smart phone.

11. The communication device for a means of conveyance of claim 10, further comprising a near-field communication module in communication with the processor.

12. A method of communicating with a means of conveyance comprising the steps of:
providing a communication device associated with the means of conveyance, the communication device having a processor, memory in communication with the processor, a cell phone transceiver in communication with the processor, a cellular antenna connected to the cellular transceiver, a GPS receiver in communication with the processor, a GPS antenna connected to the GPS receiver, a CAN Bus interface in communication with the processor and configured to allow connection to a CAN Bus of the means of conveyance, the processor configured to 1) receive data regarding the means of conveyance from the CAN Bus of the means of conveyance via the Can Bus interface and send the received data regarding the means of conveyance to only the Cloud via the cell phone transceiver, 2) receive data for the means of conveyance from only the Cloud, and 3) control the means of conveyance according to the received data for the means of conveyance utilizing the CAN Bus of the means of conveyance; and
providing an application configured to operate on a remote device of a user, the application allowing reception of data regarding the means of conveyance from only the Cloud and transmission of data regarding the means of conveyance to only the Cloud for transmission to the means of conveyance.

13. The method of claim 12, wherein the communication device further comprises an analog interface in communication with the processor and configured to connect to analog components of the means of conveyance.

14. The method of claim 13, wherein the communication device further comprises an IMU in communication with the processor.

15. The method of claim 14, wherein the remote device of a user comprises a smart phone.

16. The method of claim 15, wherein the communication device further comprises a near-field communication module in communication with the processor.

17. The Method of claim 12 wherein the means of conveyance comprises a vehicle selected from the group consisting of mobility scooters, lawn mowers, boats and power sports equipment.

18. The Method of claim 12 wherein the power sports equipment is selected from the group consisting of motorcycles, all-terrain vehicles (ATVs), utility vehicles (UTV's) snowmobiles, personal watercraft (PWC's), and scooters

19. A method for updating electronic components and controllers of a vehicle by:
Uploading the desired firmware or software update to the cloud;
Sending the updated firmware or software from the cloud to the Communication Device of the selected vehicle;
Sending the updated firmware or software from the Communication device to the components that need to be updated.
